(19) United States
(12) Patent Application Publication
(10) Pub. No.: US 2009/0033189 A1
(43) Pub. Date: Feb. 5, 2009

(54) Door Actuation Device for Actuating the Door of a Refrigerator/Freezer Cabinet

(75) Inventors: Michael Glanz, Koln (DE); Bernd Brieseck, Plettenberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Dorma GmbH + Co. KG, Ennepetal (DE)

(21) Appl. No.: 12/185,660

(22) Filed: Aug. 4, 2008

(30) Foreign Application Priority Data
Aug. 3, 2007 (DE) 10 2007 036 746.7

(51) Int. Cl. A47B 96/00; G08B 21/18; E05F 15/20

(52) U.S. Cl. 312/405; 312/326; 340/686.1; 49/29; 49/31

(57) ABSTRACT

The present invention is directed to a door actuation device for the actuation of a door of a refrigerator/freezer cabinet having a cabinet body at which at least one door is swivelably arranged. According to the invention, an automatic drive is provided which forms an operative connection between the cabinet body and the door and by which a movement of the door between a closed position and an open position can be carried out.

### CROSS-REFERENCE TO RELATED APPLICATION

This application claims priority to German Application 10 2007 036746.7, the contents of which is incorporated herein by reference in its entirety.

### BACKGROUND OF THE INVENTION

1. Field of the Invention

The present invention is directed to a door actuation device and more particularly to a door actuation device for the actuation of a door of a refrigerator/freezer cabinet having a cabinet body at which on least one door is swivelably arranged.

2. Description of the Related Art

Refrigerator/freezer cabinets having hand-actuated doors are known. Devices of this type comprise either only a handle or are constructed additionally with a lever mechanism for overcoming the suction force of the rubber seal in the closed position of the door. Therefore, opening the door usually requires a free hand of the user, which is disadvantageous when the user is holding objects which the user wants to place inside the refrigerator/freezer cabinet. This is likewise true when the user removes objects from the refrigerator/freezer cabinet and must then close the door.

Another problem of hand-actuated door actuation devices is that the door does not always automatically assume a secure closed position with respect to the cabinet body. A slightly open position of the door often goes unnoticed by the user so that a reliable cooling action of the refrigerator/freezer cabinet is not ensured and the interior of the cabinet can ice over. Further, the refrigerator/freezer cabinet remains operating at full power so that energy is unnecessarily consumed.

### SUMMARY OF THE INVENTION

It is an object of the present invention to provide a door actuation device for actuating the door of a refrigerator/freezer cabinet which is simpler to operate and ensures a reliable closed position of the door.

The invention comprises an automatic drive that is provided which forms an operative connection between the cabinet body and the door and by which a movement of the door between a closed position and an open position can be carried out.

According to one embodiment of the invention, a conventional refrigerator/freezer cabinet is expanded by an automatic drive for the door which is constructed in such a way that the door can be moved by the automatic drive so that the door can be held in the securely closed position in the cabinet body and can also be moved into any open position. The other resulting advantage is a simplified operation because the door need no longer be moved manually by the user, rather the user need merely activate and deactivate the drive.

The automatic drive preferably has a motor gear unit which acts on a door coupling element that is brought into operative connection with the door. The automatic drive comprises a housing which is arranged either in the upper region of the cabinet body in or on the roof or in the lower region of the cabinet body in the base or on the base plate. The door coupling element by which the movement is introduced into the door of the refrigerator/freezer cabinet is arranged at the housing of the automatic drive. The door coupling element can preferably be arranged on a shaft which protrudes from the housing of the automatic drive and rotates in an oscillating manner. Accordingly, the door coupling element carries out a reciprocating rotational movement and in one embodiment, can be guided at its end in a slide rail arranged in the door of the refrigerator/freezer cabinet. Alternatively, the automatic drive can be integrated in the bottom or top region of the door so that the slide rail is arranged in the cabinet body and the lever-like door coupling element extends between the drive in the door and the cabinet body.

The door is arranged on the cabinet body by means of hinges, preferably at least one hinge being provided at the top and at the bottom. Therefore, the door can also be driven by means of the door hinge acted upon by the motor gear unit of the automatic drive. A worm wheel, toothing, or spur wheel toothing of the gear unit sets the hinge pin of the door in rotation can be considered as one example of an embodiment form.

In an embodiment of the door actuation device according to the invention, the door actuation device has an electric control which cooperates with a position transmitter that provides the electric control with information about the opening position and closing position of the door. The electric control is preferably integrated in the housing of the automatic drive. The position transmitter can be designed as an incremental encoder which is arranged by its end at the motor which is preferably constructed as a DC motor. It is also possible to arrange the incremental encoder at the shaft which protrudes from the housing of the automatic drive and is arranged at the door coupling element.

Another embodiment of the position transmitter can be provided in the form of a slider potentiometer located either in the automatic drive or as an integrated component part in the slide rail inside the door. The position of the door relative to the cabinet body can also be determined by means of the slider potentiometer. Further, the position transmitter can be constructed in the form of reed contacts which make it possible to reliably detect the closing position or the opening position. Further, the automatic drive can have an accumulator to ensure a reliable driving of the door also in case of a power outage.

The automatic drive can be integrated inside the cabinet body or door in such a way that it is invisible from the outside. Further, the drive can be mounted in such a way that no noises occur. For this purpose in particular, the automatic drive can be integrated into the bottom area of the cabinet body.

According to another embodiment of the invention, the door actuation device has a spring type accumulator in which energy can be stored in the process of the door being opened by means of an electric motor, by means of which energy the door can be moved again into the closed position without the aid of the electric motor. The spring type accumulator has a compression spring that is compressed by the opening process carried out by electric motor so that energy is stored in the spring. The supply of power to the automatic drive can be prolonged, for example, to maintain the open position of the door. When the power supply to the drive is switched off, the spring type accumulator acts on the motor gear unit or on the door coupling element in such a way that the closing movement of the door is initiated by the energy stored in the spring. In this way, the complete closing of the door is made more reliable.

In one embodiment of the invention, the door actuation device preferably has a switch or a sensor that communicates with the control of the automatic drive. The switch or sensor can be actuated by a user of the refrigerator/freezer cabinet to activate the automatic drive for moving the door. Such switches or sensors can detect a slight movement of the door by a user so that the movement that is initiated is sensed by the position transmitter and the movement of the door is continued by the automatic drive. The user transmits an opening impulse or closing impulse to the door so that the automatic drive is activated by pulling slightly on the door and the door automatically moves into the open position. Conversely, the door can be moved into the open position, into the closed position or into another open position when the user merely touches the door lightly or pushes lightly against the door. The position transmitter detects the start of a movement and the movement direction in every case. As a result, the automatic drive is activated by the control so that the remainder of the movement of the door is carried out automatically. In particular, a reliable closing position of the door in the cabinet body can be ensured in this way. The sensors can be capacitive, inductive, or optical sensors. The switch is preferably constructed as a touch contact.

An automatic drive provides refrigerator/freezer cabinets with a new dimension of convenience. This is made possible by the combination of automatic opening and closing in connection with the control and the sensors.

According to an embodiment of the door actuation device, the control closes the door automatically in response to a preset maximum open time of the door. Therefore, the door of the refrigerator/freezer cabinet can be prevented from remaining open too long so that the internal temperature cannot rise above a limiting value. In addition, it is possible for the control to measure the internal temperature of the cabinet body, and the automatic drive moves the door into the closed position as soon as a preset maximum internal temperature of the cabinet body is exceeded. Temperature sensors are advantageously provided for measuring the temperature. Further, the control of the door actuation device can be coupled with the thermostat of the refrigerator/freezer cabinet which is already provided. In addition, it can be provided that an alarm signal is emitted by the control when a preset maximum open time of the door is exceeded.

Another embodiment of the door actuation device comprises an electromagnet and/or a permanent magnet which is integrated in the door and/or in the cabinet body. The automatic drive can deactivate the actuation of the door shortly before the closed position is reached so that the remainder of the movement of the door into the final closed position is carried out by the electromagnet or by the permanent magnet. Conversely, the opening of the door from the definitive closed position can be carried out by the electromagnet so that the suction effect in the rubber seal of the door in particular is overcome by the electromagnet. The subsequent movement of the door into the desired open position can be carried out by the automatic drive.

The door actuation device is preferably constructed in a modular manner in such a way that it can be fitted externally to the bottom or top of the cabinet body and door. The geometric dimensions of the door actuation device is adaptable to the dimensions of the cabinet body and door so that the structural height of the cabinet body is merely enlarged by the height of the door actuation device, and the dimensions of the door actuation device in its lateral extension are adapted to the dimensions of the cabinet body.

Another advantageous construction can be carried out through operation in powerless mode. By this is meant the manual opening of the door by hand and the automatic closing of the door by the drive. In so doing, the door remains in the held open position for a fixed opening time. The drive closes the door after the expiration of this time. An advantageous variant consists in that when closing the door, the door strikes an obstacle, which stops the door. The door then moves up by an angle of, e.g., 5° again and holds this position for a given time. The door then closes again and is subject to the preset maximum internal temperature of the refrigerator/freezer cabinet. When the reference value of the internal temperature is exceeded, the door is closed by the drive.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the drawings:

FIG. 1 shows the arrangement of a door actuation device in the roof region or in the bottom region of a refrigerator/freezer cabinet according to an embodiment of the invention;

FIG. 2 shows an automatic drive of the door actuation device with the components arranged in the drive according to an embodiment of the invention;

FIG. 3 shows a possible integration of the door actuation device in the upper region of the refrigerator/freezer cabinet according to an embodiment of the invention;

FIG. 4 shows a first embodiment example of the door actuation device with an automatic drive, a door coupling element, and a slide rail according to an embodiment of the invention;

FIG. 5 shows a second embodiment example of the door actuation device with an elongated housing of the automatic drive and the door element and slide rail according to an embodiment of the invention;

FIG. 6 shows an integration of the door actuation device in the bottom region of the refrigerator/freezer cabinet by way of example according to an embodiment of the invention; and

FIG. 7 is a perspective view of a modular door actuation device which can be fitted on the outer side at the bottom or top of the cabinet body and the door according to an embodiment of the invention.

### DETAILED DESCRIPTION OF THE PRESENTLY PREFERRED EMBODIMENTS

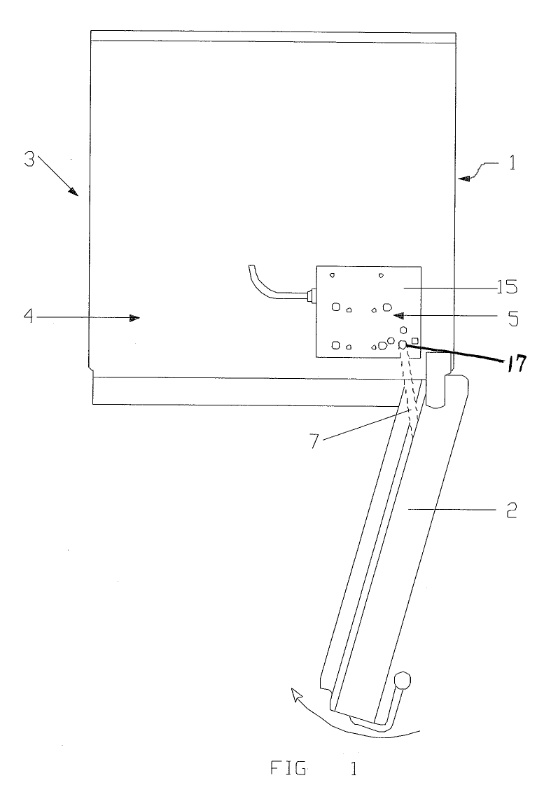

FIG. 1 shows a door actuation device 1 according to the present invention which is arranged either in the bottom region or in the top region of the cabinet body 4 of a refrigerator/freezer cabinet 3. The door actuation device 1 comprises an automatic drive 5 which has a closed housing 15 into which an electric cable for the power supply and signal supply is fed and from which a shaft 17 protrudes, a door coupling element 7 being rotatably arranged on this shaft 7. The door coupling element 7 extends between the cabinet body 4 and the door 2 of the refrigerator/freezer cabinet 3. The door 2 can be moved relative to the cabinet body 4 by a swiveling movement of the door coupling element 7. Consequently, the door 2 is movable by the automatic drive 5 between an open position (as is shown) and a closed position. The movement is indicated by an arrow at the door 2.

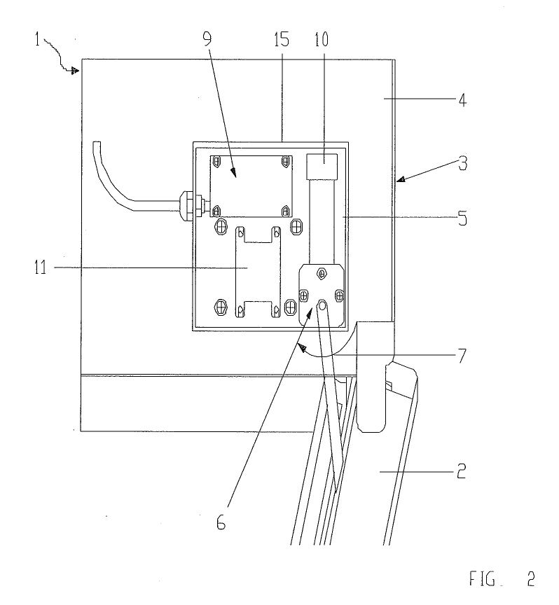

FIG. 2 shows a detailed view of the automatic drive 5 according to FIG. 1. The automatic drive 5 comprises a housing 15 which is arranged on the cabinet body 4 of the refrigerator/freezer cabinet 3. A motor gear unit 6 is integrated in the housing 15 of the automatic drive 5, and position transmitter 10 being coupled to the motor in a preferred embodiment, position transmitter 10 is arranged at an end of automatic drive 5. Further, a control 9 and a power supply 11 are integrated in the housing 15. A shaft 13, which is driven in rotation, extends from the gear unit 6, a door coupling element 7 being coupled to this shaft. The rotational movement of the door coupling element 7 is indicated by an arrow so that when the door coupling element 7 is rotated around the shaft of the gear unit a closing movement of the door 2 occurs relative to the cabinet body 4. Accordingly, the door coupling element 7 extends between the automatic drive 5 and the door 2.

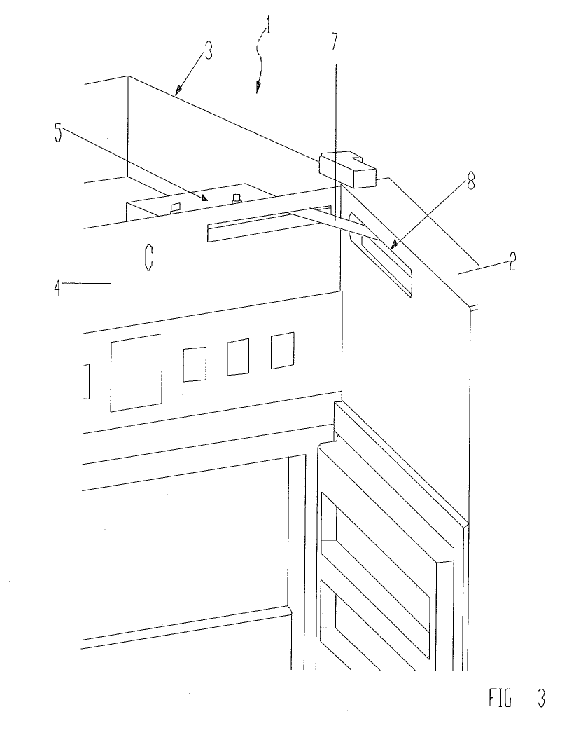

FIG. 3 shows the door actuation device 1 integrated in the top of the cabinet body 4 of the refrigerator/freezer cabinet 3. The integration of the automatic drive 5 is carried out in the roof region of the cabinet body 4 so that it is not visible to a user (the upper covering of the cabinet body 4 is removed in order to show the automatic drive 5). The door coupling element 7 extends between the cabinet body 4 and the door 2 and is guided through a longitudinal slot on the cabinet body side and on the door side. A slide rail 8 is integrated in the door 2, the end of the door coupling element 7 being guided therein so as to be movable longitudinally, preferably, by means of a sliding block. When the door coupling element 7 is set in rotation, the closing movement of the door 2 is initiated and the end of the door coupling element 7 slides along the slide rail 8. Accordingly, an automatic opening and closing movement of the door 2 relative to the cabinet body 4 is possible.

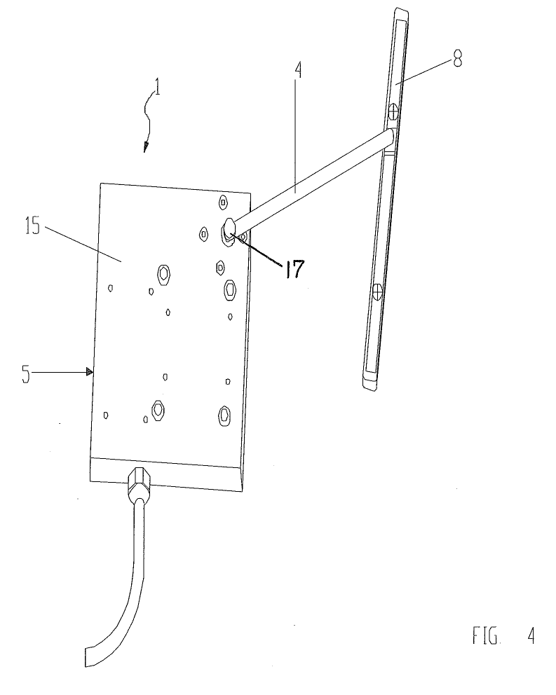

FIG. 4 shows the door actuation device 1 in the uninstalled state according to a first embodiment example. This door actuation device 1 comprises an automatic drive 5. The housing 15 of the automatic drive 5 has an approximately rectangular contour. A shaft 17 extends from the housing 15. The door coupling element 7 is coupled shaft 17 and can be set in a rotational oscillating motion by the rotation of the shaft. The door coupling element 7 is guided so as to be longitudinally movable in the slide rail 8 which is configured to be coupled to the door of the refrigerator/freezer cabinet.

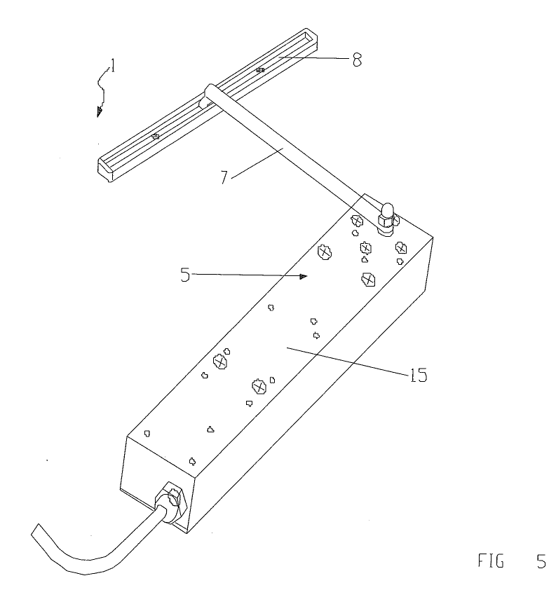

FIG. 5 shows embodiment of the door actuation device 1, having a housing 15 is constructed in an elongated manner. Consequently, the construction of the housing 15 can be adapted to the space conditions in the cabinet body of the refrigerator/freezer cabinet. The length of the door coupling element 7 and the length of the slide rail 8 are likewise adaptable to the respective installation dimensions in the cabinet body and/or in the door of the refrigerator/freezer cabinet.

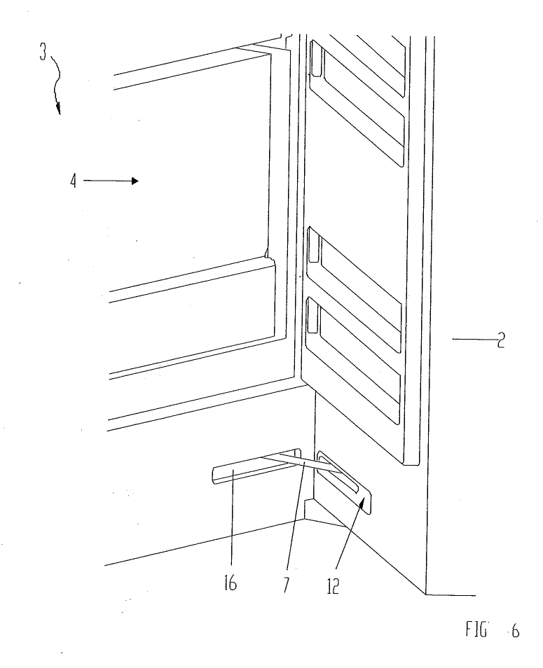

FIG. 6 shows an integration of the door actuation device on the bottom inside the refrigerator/freezer cabinet 3. The door actuation device is integrated in the bottom region so as to be invisible, the cabinet body 4 having a longitudinal slot 16 from which the door coupling element 7 protrudes. A cover panel 12 is arranged on the front side over the longitudinal slot inside the door 2. The panel 12 can also be placed over the longitudinal slot 16 in the cabinet body 4. This results in an integration of the door actuation device so that preferably only the door coupling element 7 is visible to the user.

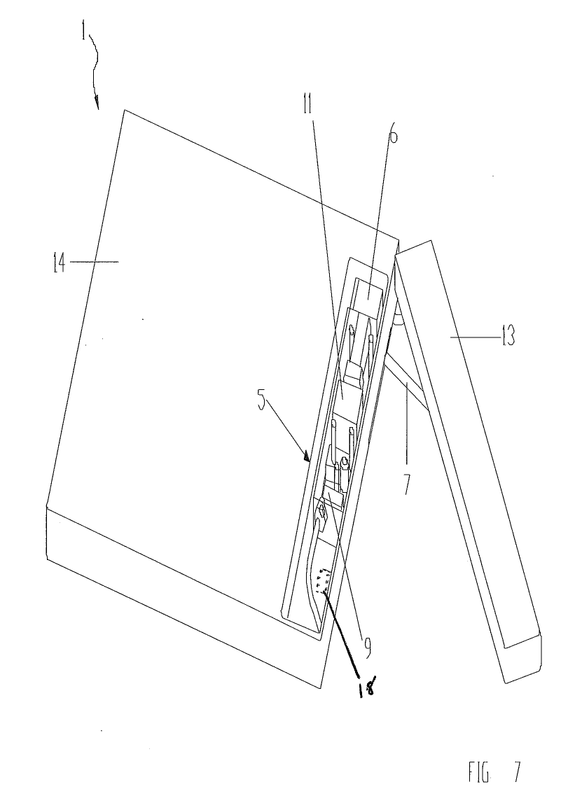

FIG. 7 shows a modular construction of the door actuation device 1 which is carried out in such a way that it can be arranged externally with respect to the bottom or at the top of the cabinet and/or door of the refrigerator/freezer cabinet. The door actuation device 1 is constructed with a door mounting element 13 and a cabinet body mounting element 14. The mounting channels 13, 14 are preferably adapted to the door and to the cabinet body of the refrigerator/freezer cabinet (not shown). The automatic drive 5 is integrated inside the cabinet body mounting element 14 at the side in the direction of the door mounting element 13. The motor gear unit 6, the power supply 11, and the control 9 are shown schematically inside the automatic drive 5. The door coupling element 7 extends between the door mounting element 13 and the cabinet body mounting element 14 to allow the door mounting element 13 to execute a swiveling movement relative to the cabinet body mounting element 14. Because of the modular construction of the door actuation device 1, a conventional refrigerator/freezer cabinet can be retrofitted with a door actuation device 1. This door actuation device 1 is simply mounted on the bottom or roof of the refrigerator/freezer cabinet so that no substantial constructional changes need to be made to the refrigerator/freezer cabinet. In one embodiment, a permanent magnet or electromagnet 18 is included in body mounting element 14. Alternatively, the magnet 18 is included in door mounting element 13.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A door actuation device for the actuation of a door of a refrigerator/freezer cabinet having a cabinet body at which at least one door is swivelably arranged, the door actuation device comprising an automatic drive adapted to form an operative connection between the cabinet body and the door and by which a movement of the door between a closed position and an open position is accomplished.

2. The door actuation device according to claim 1, wherein the automatic drive has a motor gear unit that acts on a door coupling element that is brought into operative connection with the door.

3. The door actuation device according to claim 2, wherein the door actuation device is constructed in a modular manner and is adapted for an upper region or on a lower region of the cabinet body.

4. The door actuation device according to claim 2, wherein the door has a slide rail in which the door coupling element is guided so as to be longitudinally movable.

5. The door actuation device according to claim 2, wherein an electric control is provided which cooperates with a position transmitter that provides the control with information about the opening position and closing position of the door.

6. The door actuation device according to claim 5, wherein the position transmitter is one of an incremental encoder, a slider potentiometer, or a reed contact configured sense the position of the door.

7. The door actuation device according to claim 2, further comprising a spring type accumulator, in which energy is stored in a door opening process by means of which energy the door can be moved again into the closed position.

8. The door actuation device according to claim 2, further comprising a switch or a sensor coupled with the control and actuatable to activate the automatic drive for moving the door.

9. The door actuation device according to one of claim 5, wherein the door movement is initiated by a movement of the door, the initiated movement being sensed by the position transmitter and the movement of the door being continued by the automatic drive.

10. The door actuation device according claim 5, wherein the control automatically closes the door after a maximum opening time.

11. The door actuation device according to claim 10, wherein the control receives data indicating the internal temperature of the cabinet, wherein the automatic drive moves the door into the closed position as soon as a maximum internal temperature of the cabinet is exceeded.

12. The door actuation device according to claim 10, wherein an alarm signal is emitted by the control when the preset maximum open time of the door is exceeded.

13. The door actuation device according to claim 2, wherein at least one of an electromagnet and a permanent magnet is arranged at least one of in the door and in the cabinet body, wherein a control is configured to deactivate the actuation of the door shortly before the closed position is reached and the remainder of the movement of the door into the closed position is carried out by the at least one of an electromagnet and a permanent magnet.

14. The door actuation device according to claim 2, wherein the door actuation device is constructed as a modular door actuation device in such that the door actuation device can be fitted externally to the bottom or top of the cabinet and door.

15. The door actuation device according to claim 6, wherein the movement direction of the door is predetermined by a user.

16. A cabinet assembly comprising:
a housing;
a door swivelably coupled to the housing; and
an automatic actuator coupled between the housing and the door, wherein the automatic actuator is adapted to swivel the door between an open and closed position.

17. The cabinet assembly of claim 16, further comprising a sensor adapted to activate the automatic door actuator to move the door from the either open or closed positions.

18. The cabinet assembly of claim 17, further comprising a controller, the controller configured to activate the automatic door assembly after a predetermined time period.
